(19) United States
(12) Patent Application Publication
(10) Pub. No.: US 2026/0253510 A1
(43) Pub. Date: Aug. 27, 2026

(54) Toilet Training Device and Game

(71) Applicant: Patricia Anthony, Burleson, TX (US)

(72) Inventor: Patricia Anthony, Burleson, TX (US)

(21) Appl. No.: 19/062,589

(22) Filed: Feb. 25, 2025

(51) Int. Cl. G09B 19/00; A47K 17/00

(52) U.S. Cl. CPC G09B 19/003; A47K 17/00

(57) ABSTRACT

The present invention relates to an interactive toilet training device and game designed to engage children in proper toilet use. The device includes a floating target that has a visual reaction when exposed to urine including but not limited to, sinking, changing color, and releasing dye. It features a scoring system that rewards accuracy and etiquette while penalizing misses, making potty training a fun and engaging activity.

### FIELD OF THE DISCLOSURE

The field of the present invention pertains to educational toys and training aids, specifically, those designed for toilet training young children by incorporating interactive, engaging, and reward-based elements.

### BACKGROUND OF DISCLOSURE

The present invention pertains to educational toys and training aids, with a particular focus on floating toys for toilet training young children. This invention introduces a novel toilet training target and game designed to assist in the toilet training of children.

Toilet training is a critical developmental milestone for young children and can significantly impact both children and caregivers. Traditional toilet training methods often lack the interactivity and engagement necessary to motivate children consistently, which can lead to a frustrating and prolonged training process.

Products in the realm of potty-training aids includes a variety of devices designed to encourage children to use the toilet. These devices range from simple mechanical indicators to complex systems that use musical rewards or lights to celebrate successful usage. However, many of these systems do not adequately address the need for teaching proper hygiene habits or fail to keep the child's attention over the necessary period of time to instill consistent and proper potty habits.

Additionally, existing products often do not provide any form of negative reinforcement or corrective feedback when the child fails to use the toilet properly. This includes situations where the child may urinate outside of the toilet, such as on the toilet seat or floor, which can inhibit the learning process and lead to undesirable habits.

Furthermore, many current potty-training aids are either overly simplistic, not engaging enough, or too complex for young children to operate independently without adult intervention. The psychological aspect of motivation in young children's learning is critical, and many existing products fail to tap into this effectively by either being too intimidating or too passive.

Given these challenges, there is a significant need for an innovative solution that not only makes the potty-training process engaging and interactive but also instills proper hygiene practices and provides feedback for both correct and incorrect actions.

### SUMMARY OF THE DISCLOSURE

The present invention pertains to educational toys and training aids, with a particular focus on floating toys for toilet training young children. The system is built around a uniquely designed floating target that may provide a visual reaction when exposed to urine, aimed at improving potty training experiences and outcomes. The present disclosure includes a toilet training device comprising a target and a method for playing a game.

In one non-limiting aspect of the disclosure, the target may be configured float in water and sink when exposed to urine.

In a non-limiting alternative embodiment of the disclosure, the target may be configured to react in at least one of the following ways when exposed to urine including but not limited to, changing color, releasing dye, breaking down, disintegrating, and releasing a fragrance. These responses may occur due to integrated smart materials or chemical indicators that react specifically to urine, thereby providing immediate and visual feedback.

In another non-limiting embodiment, the target may comprise one or more embedded reagent pads, each impregnated with chemically reactive substances tailored to detect specific urinary markers indicative of various health conditions.

In another non-limiting embodiment, the target may be encased in a waterproof film, wherein the film is configured to deteriorate when exposed to urine. Further, the film may be configured to react least one of the following ways when exposed to urine including but not limited to, changing color, releasing dye, breaking down, disintegrating, or releasing a fragrance.

In another alternative non-limiting embodiment, the target may be designed to look like various aesthetically appealing shapes and colors, including but not limited to a boat, an animal, or a cartoon character, to capture the interest of children.

In another non-limiting aspect of the disclosure, the invention may incorporate a method for playing a toilet training game wherein the user will gain points for urinating on the targets in the toilet and showing proper bathroom etiquette and lose points for urinating in undesignated areas. More points may be granted when the child performs additional actions such as lifting the toilet seat before use, which instills good hygiene practices. Conversely, the system may penalize undesirable actions, such as urinating on the toilet seat, rim, or floor, by deducting points, thus discouraging bad habits and reinforcing cleanliness.

Another alternative non-limiting embodiment of this disclosure may include a scoring system that can be implemented through various means, such as a digital display, a web app, or even manual tracking, providing flexibility and ease of use for caregivers.

The object of this disclosure is to transform the often tedious and frustrating task of toilet training into a fun and engaging activity for children. By integrating responsive feedback and a gamified scoring system, the invention promotes proper toilet use, improves hygiene, and accelerates the learning process, thereby providing an effective solution to the challenges of traditional potty-training methods.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 shows an oblique view of one embodiment of the toilet training device 100, with a target image 200 and a protective cover 300 (indicated by the wavy lines on the device).

FIG. 2 shows toilet training device 100 floating in a toilet.

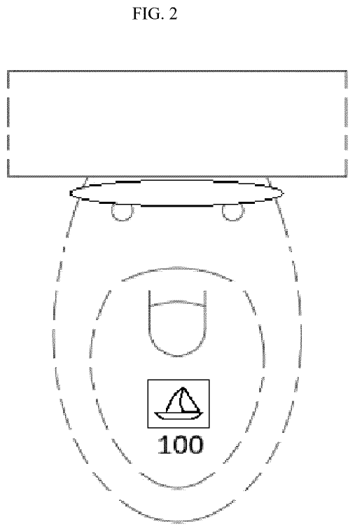

### DETAILED DESCRIPTION OF NON-LIMITING EMBODIMENTS

A more complete understanding of the devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise,” “include,” “having,” “has,” “can,” “contain,” and variants thereof, as used herein, are intended to be open-ended transitional phrases, terms, or words that require the presence of the named ingredients or steps and permit the presence of other ingredients or steps. However, such description should be construed as also describing compositions or processes as “consisting of” and “consisting essentially of” enumerated elements, such as ingredients and process steps, which allows the presence of those elements, along with any unavoidable impurities that might result therefrom, and excludes other such elements.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable, e.g., the range of “from 2 grams to 10 grams” is inclusive of the endpoints, 2 grams and 10 grams, and all the intermediate values.

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

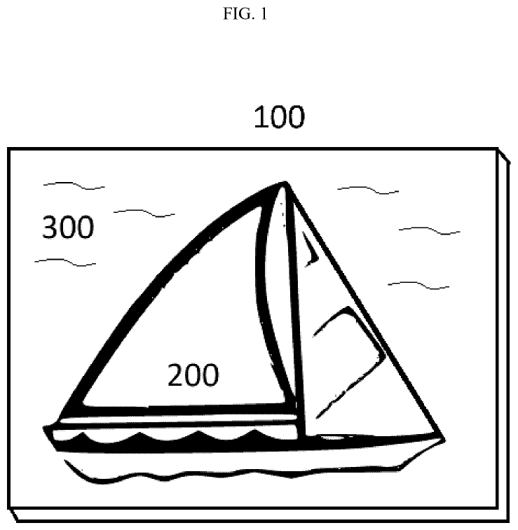

Referring now to the drawings wherein the showings are for the purpose of illustrating non-limiting embodiments of the disclosure only and not for the purpose of limiting same, FIG. 1 illustrates a non-limiting embodiment of toilet training device 100 in accordance with the present disclosure.

As shown in FIG. 1, toilet training device 100 may comprise of a target image 200. It should be appreciated that target 100 may be made of a pad of buoyant material configured to lose buoyancy when exposed to urine including but not limited to sponge, polymers, non-woven fabrics, composites, or paper. It should be appreciated that while in the current embodiment target 100 is configured to sink when exposed to urine, it is not a requirement and should be viewed as a non-limiting element. It should be appreciated that target 100 may also be made of a buoyant biodegradable material including but not limited to, biodegradable foams, starch-based materials, cellulose based sponges, natural gums and natural resins. It should be appreciated that target 100 may be made up of any shape or structure. It should be appreciated that that a user will place target 100 in a toilet and attempt to urinate on it. It should be further appreciated that toilet should be understood to include toilets, urinals, training toilets, or any other device used to receive urination.

In another non-limiting embodiment, target 100 may be made of a phosphorescent material or chemiluminescent material which is activated before use, similar to a glow stick.

In another alternative non-limiting embodiment, target 100 may be configured to change color when exposed to urine.

The color-changing method of the target 100 may be a result of a variety of methods including, but are not limited to, pH indicators that respond to the acidity or alkalinity of the urine, temperature-sensitive materials that react to the warmth of the urine, chemically sensitive polymers tailored to detect specific chemical markers in urine, enzyme-activated dyes that change color upon interacting with urinary enzymes or fluorescent dyes that alter their luminescence upon exposure to components found in urine. Target 100 may incorporate these color-changing methods either by being constructed of multiple layers or by having these materials seamlessly integrated into the structure of the target 100. Further, target 100 may be configured to change more than one color. It should be appreciated that the color changing feature will be useful in indicate to the user that they have urinated on the target. Further it should be appreciated that this feature may make it more appealing to for children to use.

In another non-limiting embodiment, target 100 may be configured to alter its reaction based upon duration of urine exposure rather than just contact. It should be appreciated that this feature could be achieved by using materials that gradually change color or pattern the longer they are exposed to urine, providing a visual representation of the duration of the urination event. It should be appreciated that this may assist in teaching children about the proper length of time required for effective toileting.

In another non-limiting embodiment target 100 may be configured to release a dye when exposed to urine. This feature may be achieved through various methods including but not limited to encasing the dye within a soluble capsule that is configured to dissolve when it comes into contact with urine, thus releasing its contents. Alternatively, the dye may be housed within a cavity of target 100 itself and target 100 may be made of a material that dissolves in the presence of urine, allowing the dye to disperse into the surrounding water. It should be appreciated that the dye may be non-toxic. It should be appreciated that the dye may be any color. It should be appreciated that the release of the dye will change the color of the toilet water. It should be appreciated that the dye may be configured to emit visible light. Further, it should be appreciated that this feature may make it more appealing for children to use.

In another non-limiting embodiment, toilet training device 100 may also comprise of a film 300 wherein at least of a portion of the toilet training device 100 or a target image 200 is covered by film 300. It should be appreciated that film 300 may be made of a waterproof material.

In another alternative non-limiting embodiment film 300 may be made of a material configured to degrade when in contact with urine including but not limited to polymers with pH-sensitive properties, hydrolytic degradation polymers, enzyme-sensitive polymers, and biodegradable films. It should be appreciated that this will assist in allowing target 100 to sink when it is urinated on. It should be appreciated that a dye may be disposed between target 10 and film 300 wherein film 300 is configured to dissolve and release the dye when exposed to urine.

In another non-limiting embodiment, target 100 may be configured to break down or dissolve when exposed to urine. It should be appreciated that this may be achieved by making the target out of materials including but not limited to polycaprolactone, carboxymethyl cellulose, starch-based materials, and polyvinyl alcohol. It should be appreciated that target 100 may also be configured to change colors and release dyes when it is breaking down or dissolving as described in the embodiments above. Further, it should be appreciated that target 100 may be configured to dissolve into a dye of any color. Further, it should be appreciated that this feature may make it more appealing for children to use.

It should be appreciated that film 300 may be configured to change color when exposed to urine. Similar to target 100 and target image 200, it should be appreciated film 300's color changing may be facilitated by a variety of methods including but not limited to, pH indicators that respond to the acidity or alkalinity of the urine, temperature-sensitive materials that react to the warmth of the urine, chemically sensitive polymers tailored to detect specific chemical markers in urine, enzyme-activated dyes that change color upon interacting with urinary enzymes or fluorescent dyes that alter their luminescence upon exposure to components found in urine. Further, it should be appreciated that film 300 may incorporate these color-changing methods either by being constructed of multiple layers or by having these materials seamlessly integrated into its structure. Further, it should be appreciated that film 300 may be configured to change more than one color.

In another non-limiting embodiment, target 100, image 200, and film 300 may be configured to emit a fragrance.

In another non-limiting embodiment, target 100, image 200, and film 300 may be configured to emit a fragrance when exposed to water.

In another non-limiting embodiment, target 100, image 200, and film 300 may be configured to emit a fragrance upon contact with urine. It should be appreciated that the fragrance will serve to counteract the typical odors associated with bathroom use and enhance the overall atmosphere of the bathroom. This aromatic feature may be achieved in any way including but not limited to embedding fragrance-releasing microcapsules within the structure of target 100, image 200, and film 300. These microcapsules would break upon contact with urine, releasing a subtle, refreshing scent. It should be appreciated that this would improve the bathroom environment and provide positive sensory feedback to the child, reinforcing the toilet training process. Further, it should be appreciated that various fragrances may be used, from soothing lavender to fresh citrus, allowing for customization based on personal preference or to further engage the child's senses.

In another non limiting embodiment, target 100 may be designed with modular components that can be interchanged. For example, different targets could be used for different training stages or to increase the difficulty level as the child's aiming skills improve. Each module could feature different colors, shapes, and reactive elements to maintain engagement over time.

In an alternative embodiment, toilet training device 100 may be reusable floatable floating targets that comprises one or more materials that temporarily change color when exposed to urine, providing immediate visual feedback upon successful contact. Once the urine is no longer present and target 100 has been rinsed or naturally flushed away, the smart materials may be engineered to revert to their original color, readying the target for repeated use. This reversible color change may be facilitated by any means including but not limited to incorporating temperature-sensitive or pH-responsive dyes that react to the presence of urine and return to their base state in its absence. It should be appreciated that this may enhance the sustainability of the training device by reducing waste and maintaining the engagement of the child by resetting the visual cue for the next training session.

In a further embodiment, the toilet training device 100 may incorporate a removable filter system designed to be installed within the toilet bowl. This filter may effectively prevent the reusable floating targets from being flushed away, ensuring they remain available for repeated use. The filter may be engineered to allow water and waste to pass through while capturing the larger, floating targets. Further, the filter may be configured to be installed at the base of the toilet bowl or over the drainage outlet and may be made from durable, water-resistant materials that can withstand the typical conditions of a bathroom environment.

In another non-limiting embodiment, target 100 may be made from material with embedded reagent pads, each impregnated with chemically reactive substances tailored to detect specific urinary markers indicative of various health conditions. These reagent areas may comprise layered pads, each treated with a distinct chemical reagent sensitive to particular urinary components including but not limited to proteins, glucose, ketones, haemoglobin, bilirubin, urobilinogen, acetone, nitrite, pH level, and leucocytes.

Each reagent pad may be designed for rapid color change in response to its corresponding urinary marker, thereby providing immediate visual feedback indicative of potential health issues. The pH-sensitive pad, for example, may contain a dye that changes color based on the urine's acidity or alkalinity, which can signal conditions like urinary tract infections or renal imbalances. Similarly, the protein-reactive pad may change color upon detecting elevated protein levels, potentially indicating kidney function disorders.

It should be appreciated that to ensure the longevity and safety of the reactive chemicals within the reagent pads, each may be encapsulated in a micro-thin layer of protective coating that prevents premature degradation or leaching of the reagents into the environment such as a colorfast coating. This protective coating may be configured to be permeable enough to allow urine to reach the reactive chemicals during use but robust enough to prevent environmental exposure during idle periods when in storage or when target 100 is floating in water. Further, it should be appreciated that the protective coatings may be selectively permeable-only allowing urine, not water, to pass through and initiate the chemical reaction. Further, it should be appreciated that target 100 may be covered with a biocompatible sealant, enhancing its safe use by ensuring that all materials in contact with the user are non-toxic and hypoallergenic. Further, it should be appreciated that sealant may also contribute to the overall durability of the target, protecting the embedded chemical reagents from moisture and mechanical wear typical in a bathroom setting. Further, it should be appreciated that an indicator sheet may be provided to assist the user. This sheet would allow for the comparison of the colors displayed on target 100 after exposure to urine with a reference chart that correlates specific color changes to potential health warnings.

In another non-limiting embodiment, a score keeping device may be included. It should be appreciated that the scorekeeping device may consist of pen and paper to a custom score board to a web application where the user can track their progress. Further, it should be appreciated that the web application may be configured to display fun animation to the user that is appealing to children.

Further, the present invention includes a method for playing an interactive potty-training game designed to make the process of toilet training engaging and educational for young children. This invention goes beyond mere functional use of potty-training devices by integrating game elements that encourage critical thinking, aim, and adherence to cleanliness standards. Specifically, the game employs floating target 100 that reacts to urine exposure in various ways as discussed above.

The game may consist of several components including a floating target, a scoring system, game instructions, and interactive components. In most embodiments all that is needed to play the game is at least one target 100 and a toilet, but it should be appreciated that additional score keeping devices may be used as well. Floating target 100 as described above are designed to react to urine exposure by sinking, changing color, or releasing dye into the toilet water. Further, it should be appreciated that target 100 may be shaped in various child-friendly forms to enhance engagement.

The scoring system may be points-based, rewarding precision and proper toilet behavior. Points may be awarded when the target is hit by urine, and additional points may be awarded if the toilet seat is lifted before urination. Further, points may be deducted if urine is misdirected onto the toilet seat, rim, or floor.

Game instructions may be provided to the user giving guidelines that explain how to set up the floating target, start the game, and keep score. These instructions will outline the point values associated with each action and the penalties for misses. In an alternative non-limiting embodiment, interactive components may include digital sensors to detect whether the toilet seat is lifted or if the target is hit accurately. These components can feed data to a digital scoreboard or a web application that tracks game progress.

Players may initiate the game by lifting the toilet seat if necessary and placing target 100 in the toilet. They then aim to urinate directly on the target. As described above in alternative non-limiting embodiments hits may result in visual feedback from the target, such as sinking or color change. Further, subjective assessments, such as judging the neatness of the attempt or additional tasks like flushing and handwashing, may be incorporated into advanced game versions, scored by parents or guardians.

In one non-limiting embodiment the game may be played as follows. First, the user obtains at least one target 100. Second, the user is instructed to get the toilet ready for urination. Third, a user places a target 100 in the water in the toilet bowl. Fourth the user is instructed to attempt to urinate on the at least one target 100. The user may also be instructed to urinate only in the toilet bowl. Finally, the points are added up. The game may be reset by flushing the toilet and placing at least one target 200 in the toilet.

A non-limiting example of a possible scoring system is shown below:

| Action | Points |
|---|---|
| Open Toilet Lid | +1 |
| Open Toilet Seat | +3 |
| Per Target Hit | +1 |
| All Targets Hit | +10 |
| Pee On Toilet Bowl Rim | −1 |
| Pee On Toilet Seat (If not Open) | −2 |
| Pee On Any Other Part of Toilet | −3 |
| Pee Anywhere Outside Toilet | −4 |
| Flush Toilet | +1 |
| Clean Up Any Mess | +3 |

Any point values may be used to the score the game; the above chart is only a non-limiting example. Similarly, any point scoring action may be used to score points and that the ones listed in the chart above should be seen as a non-limiting example. For example, different color, sized, and shaped targets 100 may be assigned different scores. Further, different bathroom etiquette may also be used to score points such as the user washing and drying their hands and closing the toilet seat and lid. Further, any scoring methods and point values may be used but that the game should focus on rewarding the user for urinating on the targets 100. However, while urine may splash onto a target 100 when hitting the water or the side of the toilet bowl and a scorer might count those as successful and deserving of points early in the potty-training period, the game might be played at a higher level of difficulty and then award points only when urine directly hits a target.

A legend of components discussed herein follows:
Target 100
Image 200
Film 300

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall therebetween.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. A toilet training device comprising a buoyant target configured to react to urine exposure.

2. The device as described in claim 1, wherein the reaction is visual.

3. The device as described in claim 2, wherein the target reacts to urine by at least one process selected from the group comprising of sinking, changing color, releasing dye, releasing fragrance, breaking down, and dissolving.

4. The device as described in claim 1, wherein the target is made of a biodegradable material.

5. The device as described in claim 1, wherein the target is at least partially covered by a waterproof film.

6. The device as described in claim 5, wherein the waterproof film degrades when exposed to urine.

7. The device as described in claim 5, wherein the waterproof film is biodegradable.

8. The device as described in claim 1, wherein the target unfolds into a predetermined structure when exposed to water.

9. The device as described in claim 2, wherein the target comprises one or more embedded reagent pads, each impregnated with chemically reactive substances tailored to detect specific urinary markers indicative of various health conditions.

10. The device as described in claim 1, wherein the target comprises one or more materials that temporarily change color when exposed to urine, providing immediate visual feedback upon successful contact.

11. A method for playing a toilet-training game comprising:
a. A toilet and a at least one target, wherein the target is buoyant;
wherein the toilet comprises a lid configured to be lifted, a seat configured to be lifted, and a toilet bowl with a cavity configured to hold water;
b. placing the at least one target in a toilet bowl;
c. instructing the user to aim urine on the at least one target; and
d. awarding points for urinating on the at least one target.

12. The method as claimed in claim 11, wherein the target is configured to have a visual reaction to urine.

13. The method as described in claim 11, wherein the target reacts to urine by at least one process selected from the group comprising of sinking, changing color, releasing dye, releasing fragrance, breaking down, and dissolving.

14. The method as described in claim 11, wherein a scoring pad may be provided.

15. The method as described in claim 11, wherein the target has a waterproof film around it.

16. The method as described in claim 11, wherein points are deducted if urine makes contact outside of the toilet bowl cavity.

17. The method as described in claim 11, wherein points may be scored for bathroom etiquette.

18. The method as described in claim 11, wherein point bonuses may be awarded for at least one action selected from the group comprising of:
a. urine contacting a target;
b. no urine contacting the toilet bowl rim;
c. no urine contacting the seat;
d. no urine going outside of the toilet;
e. lifting the toilet seat;
f. lifting the toilet lid;
g. closing the toilet seat and lid when finished, flushing the toilet when finished; and
h. hitting all of the targets.

19. A method for playing a toilet-training game comprising:
a. Providing a toilet and at least one target;
wherein the toilet comprises a lid configured to be opened and closed, a seat configured to be lifted, and a toilet bowl configured to hold water;
wherein the target is buoyant and configured to react to urine by at least one process selected from the group comprising of sinking, changing color, releasing dye, releasing fragrance, breaking down, and dissolving Instructing a user to aim urine at the floating target, wherein successful contact with the target results scoring points;
b. Awarding points based on the user's performance, wherein point may be awarded for at least one action selected from the group comprising of:
i. Successfully hitting the target with urine;
ii. Lifting the toilet lid prior to urination; and
iii. Lifting the seat prior to urination;
c. Deducting points for urine contacting anywhere outside the toilet bowl; and
d. Totaling up the points.

20. The method as described in claim 19 wherein at least a portion of the target is covered by a waterproof film.
